(19) United States
(12) Patent Application Publication
(10) Pub. No.: US 2024/0383810 A1
(43) Pub. Date: Nov. 21, 2024

(54) SILICON COMPOSITION AND ITS APPLICATION AS AN ADDITIVE FOR REDUCING WATER UPTAKE ENHANCING COMPRESSIVE STRENGTH IN CEMENT INDUSTRY

(71) Applicant: Wacker Metroark Chemicals Pvt. Ltd., Kolkata (IN)

(72) Inventors: Amit Kumar PAUL, Kolkata (IN); Abhijit TARAFDAR, Chandannagar (IN)

(73) Assignee: Wacker Metroark Chemicals Pvt. Ltd., Kolkata, WB (IN)

(21) Appl. No.: 18/569,481

(22) PCT Filed: Jun. 13, 2022
(86) PCT No.: PCT/IB2022/055431

§ 371 Date: Dec. 12, 2023

(30) Foreign Application Priority Data
Jun. 12, 2021 (IN) 202131026247

(51) Int. Cl. C04B 24/42; C04B 14/06; C04B 24/12; C04B 103/30; C04B 103/50

(52) U.S. Cl. CPC C04B 24/42; C04B 14/06; C04B 24/121; C04B 2103/302; C04B 2103/50

(57) ABSTRACT

A compressive strength improving, water uptake reducing additive composition comprising: an alkyl silane or its hydrolysate or mixture thereof comprising a silicon resin comprising units of the formula (Ia) thereof along with an additive composition and an antifoam composition; wherein the composition is used before, or during the grinding process in the cement plant not only reduces the energy consumption during grinding but also eliminates any further addition of the hydrophobic additive material to render hydrophobicity along with the improved compressive strength of the constructed structure. Such hydrophobicity along with the improved compressive strength of the constructed structure is achieved even when the composition is used after the grinding process.

### FIELD OF INVENTION

The present invention relates to an additive composition comprising an alkyl silane or its hydrolysate or mixture thereof comprising a silicon resin that provides compressive strength improving and reduces water uptake. Said additive can be added to cement composition to improve its compressive strength and hydrophobicity.

### BACKGROUND OF THE INVENTION

The total cement manufactured each year worldwide is approximately four billion metric tons (world production and capacity table as per US Geological survey in link https://pubs.usgs.gov/periodicals/mcs2020/mcs2020-cement.pdf). There are almost 3300 facilities or plants that manufactures cement worldwide. In India alone there are more than 560 cement plants which produces about 545 million tons per annum and India is 2^{nd} largest cement producer in the world after China. In India, the cement sector has been categorized on the basis of products and process involved into seven sub-sectors—Portland Pozzolana Cement (PPC), Portland Composite Cement (PCC), Ordinary Portland Cement (OPC), Portland Slag Cement (PPC), Wet Plants, White Plants, Grinding Plants and clinkerisation plants. In construction industry the major problem that needed to be addressed for all construction material is the proper protection of the construction from the moisture, since due to moisture all construction materials lead to lifetime reduction. There are different approaches that are opted to keep the construction material away from moisture. After completing the construction of the desired structure, coating the structure so as to prevent moisture from direct contact on the outer surface e.g. painting or weather coat etc. The other approach of preventing the moisture is by premixing the ingredient with the basic elements of construction e.g. cement, small aggregate and/or large aggregate which will after desired structure formation come to the surface and form a moisture repelling effect. Other approach is to change the inherent property of the basic ingredients of the building material so that no separate additive may be used to get the maximum desired protection from moisture without losing any other properties of that ingredients. One of the major issues of using or adding a hydrophobic additive material in cement is that, it drastically decreases the compressive strength of the mortar, plaster or concrete prepared by such additive mixed cement. Thus, there is a need to achieve a desired cement additive composition that render hydrophobicity by maintaining the desired compressive strength in the mortar, plaster or concrete.

In cement industry, another major issue that the manufacturing unit faces, is the amount of energy consumption. In India, the total reported energy consumption of 85 designated consumers is about 15.01 MTOE (million tons of oil equivalent as per bureau of energy efficiency, https://beeindia.gov.in/node/166). Total electrical energy consumption for cement production is about 100 kWh/ton of cement, roughly two thirds are used for particle size reduction. About 65% of the total electrical energy used in a cement plant is utilized for the grinding of coal, raw materials, and clinker.

In the cement industry hydraulic cement which is an inorganic material that have the ability to react with water under ambient conditions to form a hardened and water-resistant product, which is by far the most important and widely used cement. The manufacturing of such hydraulic cement involves the process of calcining a mixture of argillaceous and a calcareous material to produce a clinker that is sintered. Portland cement is the most widely used hydraulic cement which is produced by sintering calcareous material and argillaceous material to form a clinker and then ground with gypsum (3-3.5%) to obtain the desired setting properties. Small amount of other ingredients is also added during the grinding of the clinker material. One of the most commonly addition of such material is a grinding aid which increases the efficiency of grinding operation thereby reducing the power required for such grinding process which either decreases the plant investment or improves the throughput.

There are many grinding aid compositions known in the prior art those again added as separate additive in the cement will incur further cost to the product thus will be less competitive.

Materials such as glycols, alkanolamines, aromatic acetates, etc., have been shown to reduce the amount of energy required and thereby improve the efficiency of the grinding of clinkers. But there is no such composition that added as aid for grinding will also impart the property of repelling water of the constructed material as well as maintaining the desired mechanical property such as compressive strength of the concrete, plaster or mortar thus formed.

In U.S. Pat. No. 3,333,776A titled hydrophobic silica as a grinding aid, In Para 1, line 48-53, it is mentioned that silica powder rendered hydrophobic by treating with hydrophobic organosilicon causes marked improvement in Grinding process (more rapid and finely ground) than grinding without silica or in the presence of untreated, hydrophilic silica. Though the composition mentions hydrophobic property, but this do not give the desired effect of hydrophobization of the cement or the final construction.

In WO2000039047A1 titled Silicon containing grinding aides for clinker. In this reference the grinding aid is added to the cement clinker to reduce the energy consumed during grinding and/or to improve the properties of the hydraulic cement product. The grinding aid can be a cyclic siloxane, a functionalized polydiorganosiloxane, or mixtures thereof. It is also mentioned that in addition to the monomeric alkoxysilane, oligomeric products from partial hydrolysis and condensation of alkoxy silanes can also be used in the composition of this invention. Though the composition mention silicone composition but do not render desired combined hydrophobic property and compressive strength on the cement or the final construction.

In WO2000039046A1 titled Silicon containing grinding aides for slag discloses grinding aid for slag and slag/clinker raw material blends. The grinding aid is any silicon containing fluid or blends thereof. It is mentioned that in addition to the monomeric alkoxysilane, oligomeric products from partial hydrolysis and condensation of alkoxy silanes can also be used in the composition of this invention. Though the composition mention silicone composition but do not render desired combined hydrophobic property and compressive strength on the cement or the final construction.

In GB1112018 A titled a process for the production of finely divided materials, producing finely-divided materials comprises grinding in a ball-type mill a composition consisting of (a) 10 parts by weight of a particulate, non-malleable, brittle, solid material, (b) from 0.1 to 2 parts by weight of a silica powder having a surface area of at least 20 square metres per gram, the surface of which has been rendered hydrophobic by treatment with an organosilicon compound selected from organo- and haloorgano-silazanes, organo- and haloorgano-siloxanes, and hydroxyl-reactive organo- and haloorgano-silanes, and (c) from 5 to 20 parts by weight of a volatile, inert liquid that is not a solvent for (a), where the mixture of (a), (b) and (c) is a free-flowing slurry throughout the grinding process. Though the composition mention silicone composition but do not render hydrophobic property on the cement or the final construction.

In U.S. Pat. No. 6,635,109 titled process of making cements with silicon containing grounding aid, in the abstract a grinding aid is added to the cement clinker before it is ground in (iii). The grinding aid is an uncalcined direct process residue gel, which is a hydrolysis product of alkylhalodisilanes produced as by-products in the manufacture of alkylhalosilanes. Though the composition mention silicone composition but it does not render desired hydrophobic property on the cement or the final construction. Moreover, due to the presence of halogen group the corrosion reaction increases with the iron bars present in concrete.

In U.S. Pat. No. 7,160,384B2 disclosed is a method of introducing into a grinding mill, wherein cement clinker is ground to provide cement powder, a diamine such as tetrahydroxylethylethylene diamine, and an alkanolamine such as triethanolamine or triisopropanolamine. The combination of the diamine and alkanolamine provides superior grinding efficiency compared to diamine or alkanolamine added separately. This composition do not mention final hydrophobicity of the composition and compressive strength properties.

In CN108840597A, components the present reference relates to a kind of modified triethanolamine grinding aid: First modified triethanolamine, the second modified triethanolamine, molasses, silicone emulsion, sodium pyrophosphate, water. A kind of modified triethanolamine grinding aid of the present invention, grinding aid are adsorbed in solid particles surface, change the architectural characteristic of particle surface, prevent particle aggregation, improve material fluidity, can effectively prevent the closure of newborn crackle, accelerates the extension of material crackle, it can be eliminated promptly or weaken the aggregation and adherence between particle and particle, 12% or more mill efficiency raising, 3d gain in strength >=5 MPa, 28d gain in strength >=6 MPa, presetting period >=200 min, final setting time≤300 min.

This is a different composition and do not give the desired hydrophobicity, strength, and reduction in grinding energy. Here, the triethanolamine is present 30 parts and siloxane (in siloxane emulsion) is 25% of 4 parts i.e. 1 part, hence ratio of triethanolamine to siloxane is 90:3, which do not work for the desired result of both compressive strength and water absorption.

In U.S. Pat. No. 9,028,609B2, an additive composition including a grinding aid selected from glycols, monocarboxylic acids with 1 to 4 carbon atoms, and comb polymers; as well as at least one retardant, which can be used during the process of grinding cement clinker and which leads to low brown discoloration of the ground cement in the processed state.

In U.S. Pat. No. 8,470,925B2, here the aqueous emulsion of silicone resin is used as solid coating film and used to cover top surfaces to impart water resistance/repellence and improve weather protective properties. Such composition is different and have 1.7 mol % of R group are octyl radical and rest are methyl and it thus may not impart water resistance/repellency property when used in the bulk composition and may not render sufficient compressive strength property.

Thus, though there are references that discusses hydrophobicity property and the grinding aid, there remains a need for a stable composition that reduces the energy consumption in the cement plant along with the desired rendering of bulk hydrophobic property and better compressive strength of the construction product as an additive composition.

It is desired to add minimum quantity of additives in the basic construction material such as in cement, so that other important properties such as strength and durability is not compromised. It is important to optimize the cement price by controlling the minimum quantity of additive addition during the production of cement. Cement market is highly price-competitive. Therefore, the present invention seeks to provide an additive for treatment of cement which is added in minimum quantity during the production of cement making it competitive yet having the desired strength and durability.

### OBJECT OF INVENTION

One of the objectives of the invention is to minimize the usage of admixture or addition of additive material in construction material specifically but not restricted to cement. The other objective of the current invention is the reduction of processing energy in the construction material plant, specifically but not restricted to the grinding process in the cement plant.

Another objective of the current invention is to achieve the final hydrophobic property of the constructed structure without losing compressive strength without further adding any additive.

### SUMMARY OF INVENTION

In an aspect the present invention provides a compressive strength improving, water uptake reducing additive composition comprising:
an alkyl silane or its hydrolysate or mixture thereof comprising a silicon resin comprising units of the formula (Ia)

(R¹O)ₐR²_{b}R³_{c}SiO_{(4-a-b-c)}/2 (Ia),
where,
R¹ is same or different and is hydrogen atom, a monovalent alkyl group with 1-4 carbon atoms,
R² is same or different and is a monovalent alkyl group with 1-3 carbon atoms,
R³ is same or different and is a monovalent alkyl with at least 4 carbon atoms,
a is 0, greater than 0 and less than or equal to 3,
b is 0, greater than 0 and less than or equal to 3,
c is 0, greater than 0 and less than or equal to 3,
with the provisos that a+b+c≤3,
in more than 50 percent of all units of formula (Ia), b is less than c, where, a, b, c is same or different and are integers or a fraction either each unit or in an average unit.

In another aspect the present invention provides a compressive strength improving, water uptake reducing, self-dispersible mixture additive composition comprising: an alkyl silane or its hydrolysate or mixture thereof comprising a silicon resin (or oligomer) comprising units of the formula (Ia)

(R¹O)ₐR²_{b}R³_{c}SiO_{(4-a-b-c)}/2 (Ia),
where,
R¹ is same or different and is hydrogen atom, a monovalent alkyl group with 1-4 carbon atoms,
R² is same or different and is a monovalent alkyl group with 1-3 carbon atoms,
R³ is same or different and is a monovalent alkyl with more than 4 carbon atoms, and specifically 4-20 carbon atoms,
a is 0, greater than 0 and less than or equal to 3,
b is 0, greater than 0 and less than or equal to 3,
c is 0, greater than 0 and less than or equal to 3,
with the provisos that a+b+c≤3,
in more than 50 percent of all units of formula (Ia), b is less than c, where, a, b, c is same or different and are integers or a fraction either each unit or in an average unit.

In a further aspect the present invention provides a compressive strength improving, water uptake reducing cement composition comprising:
a) 0.01 to 5% by weight of a compressive strength improving, water uptake reducing additive composition comprising:
an alkyl silane or its hydrolysate or mixture thereof comprising a silicon resin (or oligomer) comprising units of the formula (Ia)

(R¹O)ₐR²_{b}R³_{c}SiO_{(4-a-b-c)}/2 (Ia),
where,
R¹ is same or different and is hydrogen atom, a monovalent alkyl group with 1-4 carbon atoms,
R² is same or different and is a monovalent alkyl group with 1-3 carbon atoms,
R³ is same or different and is a monovalent alkyl with 4-20 carbon atoms,
a is 0, greater than 0 and less than or equal to 3,
b is 0, greater than 0 and less than or equal to 3,
c is 0, greater than 0 and less than or equal to 3,
with the provisos that a+b+c≤3,
in more than 50 percent of all units of formula (Ia), b is less than c, where, a, b, c is same or different and are integers or a fraction either each unit or in an average unit;
b) 15% to 35% of a pozzolanic material; and
c) 60% to 80% of a clinker.

As defined by American Concrete institute, a pozzolan is a siliceous or siliceous and aluminous material that in itself possesses little or no cementitious value but will, in finely divided form and in the presence of moisture, chemically react with calcium hydroxide at ordinary temperatures to form compounds having cementitious properties. It is therefore classified as cementitious material. There are both natural (ACI 232.1R) and artificial (fly ash, ACI 232.2R, and silica fume, ACI 234R) pozzolans. Non limiting descriptions of various kinds of pozzolans and specifications for them are given in ASTM C618 and ASTM C1240.

Clinker is defined as (1) a partially fused product of a kiln that is ground to make cement.
(2) other vitrified or burnt material. Whereas, concrete is a mixture of hydraulic cement, aggregates, and water, with or without admixtures, fibers, or other cementitious materials.

In yet a further aspect the present invention provides a cement mortar or concrete composition comprising:
I) a cement composition comprising:
   0.01 to 5% by weight of a cement additive composition comprising:
      a) 0.01 to 100% of a compressive strength improving, water uptake reducing additive composition comprising:
an alkyl silane or its hydrolysate or mixture thereof comprising a silicon resin comprising units of the formula (Ia)

(R¹O)ₐR²_{b}R³_{c}SiO_{(4-a-b-c)}/2 (Ia),
where,
R¹ is same or different and is hydrogen atom, a monovalent alkyl group with 1-4 carbon atoms,
R² is same or different and is a monovalent alkyl group with 1-3 carbon atoms,
R³ is same or different and is a monovalent alkyl with 4-20 carbon atoms,
a is 0, greater than 0 and less than or equal to 3,
b is 0, greater than 0 and less than or equal to 3,
c is 0, greater than 0 and less than or equal to 3,
with the provisos that a+b+c≤3,
in more than 50 percent of all units of formula (Ia), b is less than c, where, a, b, c are same or different and are integers or a fraction either each unit or in an average unit.
b) 0 to 69.99% of an additive selected from (a) an amino silane, (b) an amino siloxane or (c) an organic additive selected from a hyperbranched polycarboxylate polymer or molecules having groups NR″₂—, or R″₂N—R′″—NR″— or R″N=NR″, where, R″, R′″ is an optionally substituted aromatic or aliphatic hydrocarbon radical having C₁-C₂₀ group, or its mixtures thereof;
c) 0 to 30% of an antifoam composition selected from a silicone antifoam composition and a non-silicone antifoam composition and its mixtures thereof; and
II) a silica composition,
wherein, the concrete or mortar composition having a compressive strength improvement in the range of 10 to 30% determined according to DIN EN 12390-3 or DIN EN 196-1 respectively and having a reduction of water uptake in the range of 10 to 40% according to ASTM C1585 in the concrete or mortar.

The present invention surprisingly found that a compressive strength improving, water uptake reducing cement additive composition comprising,—an alkylalkoxysilane of formula (Ib) or its hydrolysate or mixture thereof along with an organic/organosilicone additive and/or an antifoam composition; wherein the composition is used before, during the grinding process in the cement plant not only reduces the energy consumption during grinding but also eliminates any further addition of the hydrophobic additive material to render hydrophobicity along with the improved compressive strength of the constructed structure. Such additive composition if added after grinding process will reducing water uptake and enhancing compressive strength.

### DETAILED DESCRIPTION

A compressive strength improving, water uptake reducing additive composition comprising:
an alkyl silane or its hydrolysate or mixture thereof comprising a silicon resin (or oligomer) comprising units of the formula (Ia)

(R¹O)ₐR²_{b}R³_{c}SiO_{(4-a-b-c)}/2 (Ia),
where,
R¹ is same or different and is hydrogen atom, a monovalent alkyl group with 1-4 carbon atoms,
R² is same or different and is a monovalent alkyl group with 1-3 carbon atoms,
R³ is same or different and is a monovalent alkyl with 4-20 carbon atoms,
a is 0, greater than 0 and less than or equal to 3,
b is 0, greater than 0 and less than or equal to 3,
c is 0, greater than 0 and less than or equal to 3,
with the provisos that a+b+c≤3,
in more than 50 percent of all units of formula (Ia), b is less than c, where, a, b, c is same or different and are integers or a fraction either each unit or in an average unit.

Where, the alkyl silane of formula (Ib) or its hydrolysate or mixture thereof

(X)₄₋ₙSiR′ₙ (Ib)
where, n is any number from 1 to 3, X is same or different and is a halide (fluoride, chloride, bromide, Iodide), an alkoxide (—OR), where R is same or different and is a C₁-C₂₀ group, R′ is same or different and is a C₁-C₂₀ group.

In one of the embodiments, the additive composition, may further comprise an antifoam composition selected from a silicone antifoam composition and a non-silicone antifoam composition and its mixtures thereof.

In another embodiment, the additive composition, may further comprise:
an additive selected from (a) an amino silane, (b) an amino siloxane or (c) an organic additive selected from a hyperbranched polycarboxylate polymer or molecules having groups NR″₂—, or R″₂N—R′″—NR″— or R″N=NR″, where, R″, R′″ is an optionally substituted aromatic or aliphatic hydrocarbon radical having C₁-C₂₀ group, or its mixtures thereof.

In one of the embodiment. ratio of hydrolysate of alkyl silane or mixture to additive to antifoam composition is from (100 to 20):(80 to 0):(20 to 0).

In one embodiment, the additive composition, wherein the alkyl silane of formula (Ib) or its hydrolysate or mixture composition formula (Ia) is emulsified or is in a solvent. The preferred solvents may include acetone, acetonitrile, alcohols, formaldehyde, ether, ethyl acetate, aromatic solvents (Toluene, Xylene etc), halogenated organic solvents (Methylene chloride, Chloroform, Carbon tetrachloride etc), hydrocarbons (Hexane, Gasoline, Kerosene, White spirit). It may also include, the organic solvent for example, it includes an aromatic solvent such as benzene, xylene, toluene, ethylbenzene, n-butylbenzene, t-butylbenzene and isopropylbenzene, a lower ester solvent such as methyl acetate, ethyl acetate, isopropyl acetate and methyl propionate and a ketone solvent such as acetone, methylethylketone and diethylketone. A solvent may be used in combination with another. The solvent may be preferably used in such an amount that the content of the silane and its hydrolysate may range from 5 to 95 percent by weight in the slurry. glycol ethers include but not limited to di(oxypropylene)glycol-t-butyl ether (DPTB), di(oxypropylene)glycol-n-butyl ether (DPNB), or a mixture thereof. The solvent may additionally include a low molecular glycol such as di(oxypropylene)glycol (DPG), di(oxyethylene)glycol (DIEG), or mixture thereof. It may be also hydrocarbon solvent, such as benzene, turpentine, pine oil, rosin, or aliphatic solvent, for example, petroleum ether or gasoline.

In one of the embodiments, the compressive strength improving, water uptake reducing self-dispersible mixture additive composition comprising:
a hydrolysate of alkyl silane or mixture thereof comprising a silicon resin (or oligomer) comprising units of the formula (Ia)

(R¹O)ₐR²_{b}R³_{c}SiO_{(4-a-b-c)}/2 (Ia),
where,
R¹ is same or different and is hydrogen atom, a monovalent alkyl group with 1-4 carbon atoms,
R² is same or different and is a monovalent alkyl group with 1-3 carbon atoms,
R³ is same or different and is a monovalent alkyl with 4-20 carbon atoms,
a is 0, greater than 0 and less than or equal to 3,
b is 0, greater than 0 and less than or equal to 3,
c is 0, greater than 0 and less than or equal to 3,
with the provisos that a+b+c≤3,
in more than 50 percent of all units of formula (I), b is less than c, where, a, b, c is same or different and are integers or a fraction either each unit or in an average unit.

In another embodiment, the self-dispersible mixture additive composition, further comprising an antifoam composition selected from a silicone antifoam composition and a non-silicone antifoam composition and its mixtures thereof.

In one embodiment, the self-dispersible mixture additive composition, further comprising:
an additive selected from (a) an amino silane, (b) an amino siloxane or (c) an organic additive selected from a hyperbranched polycarboxylate polymer or molecules having groups NR″₂—, or R″₂N—R′″—NR″— or R″N=NR″, where, R″, R′″ is an optionally substituted aromatic or aliphatic hydrocarbon radical having C₁-C₂₀ group, or its mixtures thereof.

In one of the embodiments, a compressive strength improving, water uptake reducing cement composition comprising:
a) 0.01 to 5% by weight of a compressive strength improving, water uptake reducing additive composition comprising:
a hydrolysate of alkyl silane or mixture thereof comprising a silicon resin comprising units of the formula (Ia)

(R¹O)ₐR²_{b}R³_{c}SiO_{(4-a-b-c)}/2 (Ia),
where,
R¹ is same or different and is hydrogen atom, a monovalent alkyl group with 1-4 carbon atoms,
R² is same or different and is a monovalent alkyl group with 1-3 carbon atoms,
R³ is same or different and is a monovalent alkyl with 4-20 carbon atoms,
a is 0, greater than 0 and less than or equal to 3,
b is 0, greater than 0 and less than or equal to 3,
c is 0, greater than 0 and less than or equal to 3,
with the provisos that a+b+c≤3,
in more than 50 percent of all units of formula (I), b is less than c, where, a, b, c is same or different and are integers or a fraction either each unit or in an average unit;
b) 15% to 35% of a pozzolanic material; and
c) 60% to 80% of a clinker.

In another embodiment, the cement composition, wherein the organic additive comprising a diamine or an alkanolamine or its mixture thereof.

A cement mortar or concrete composition comprising:
I) a cement composition comprising:
   0.01 to 5% by weight of a cement additive composition comprising:
      a) 0.01 to 100% of a compressive strength improving, water uptake reducing additive composition comprising:
a hydrolysate of alkyl silane or mixture thereof comprising a silicon resin comprising units of the formula (Ia)

(R¹O)ₐR²_{b}R³_{c}SiO_{(4-a-b-c)}/2 (Ia),
where,
R¹ is same or different and is hydrogen atom, a monovalent alkyl group with 1-4 carbon atoms,
R² is same or different and is a monovalent alkyl group with 1-3 carbon atoms,
R³ is same or different and is a monovalent alkyl with 4-20 carbon atoms,
a is 0, greater than 0 and less than or equal to 3,
b is 0, greater than 0 and less than or equal to 3,
c is 0, greater than 0 and less than or equal to 3,
with the provisos that a+b+c≤3,
in more than 50 percent of all units of formula (I), b is less than c, where, a, b, c is same or different and are integers or a fraction either each unit or in an average unit.
   b) 0 to 69.99% of an additive selected from (a) an amino silane, (b) an amino siloxane or (c) an organic additive comprising selected from a hyperbranched polycarboxylate polymer or molecules having groups NR″₂—, or R″₂N—R′″—NR″— or R″N=NR″, where, R″, R′″ is an optionally substituted aromatic or aliphatic hydrocarbon radical having CJ-C20 group, or its mixtures thereof,
   c) 0 to 30% of an antifoam composition selected from a silicone antifoam composition and a non-silicone antifoam composition and its mixtures thereof; and
II) a silica composition,
wherein, the concrete or mortar composition having a compressive strength improvement in the range of 10 to 30% determined according to DIN EN 196-1 and having a reduction of water uptake in the range of 10 to 40% according to ASTM C1585 in the concrete or mortar.

In another embodiment, cement additive composition, where the composition further comprises 0 percent to less than 50 percent of a silane composition of formula (II)

(R⁴O)₄₋ₙ₋ₘSiR⁵ₙR⁶ₘ (II)
where, n is any number from 0 to 3, m is any number from 1 to 3, R⁵ is same or different and is a monovalent alkyl group with 1-4 carbon atoms, R⁶ is same or different and is a monovalent alkyl with 1-20 carbon atoms.

In one embodiment, the additive composition, where the silicone resin is from 10 percent to 100 percent of a mixture of the silicone resin (having greater than equal to 40 percent of octyl group, preferably greater than equal to 50 percent of octyl group in the RSiO_{3/2} group which is more than 50% in the silicone resin) and the silane composition, preferably from 20 percent to 100 percent of a mixture of the silicone resin (having greater than equal to 40 percent of octyl group, preferably greater than equal to 50 percent of octyl group) and the silane composition.

According to an embodiment of present invention, the silane or the hydrolysate (silicone resin) provides hydrophobicity into the porous product preferably dry cement whereas the nonionic emulsifier contributes to disperse the silane or the hydrolysate (silicone resin) in polar solvent and helps in application in the bulk of the cement or plaster on uniform cement particle coating of silane or hydrolysate. The bulk hydrophobicization is advantageous in that the entire volume of the component gets the hydrophobic character and not only the surface thereof, so even if the hydrophobic surface is chipped, the hydrophobicity along with the compressive strength is maintained in the concrete or final structure thus formed. Thus, both the components alkyl silane or its hydrolysate or mixture thereof comprising a silicon resin and optionally antifoam composition and further optionally additive composition along with or without emulsifier in together act synergistically to provide the desired hydrophobicity, maintaining the compressive strength. To be a very surprising phenomenon of this composition which when added before or during grinding, also helps to reduce the power or electricity consumption and reduces time during grinding process.

In one embodiment, the cement additive composition having the alkylalkoxysilane of formula (Ib) or its hydrolysate or mixture composition is emulsified or is in a solvent or as a mixture.

In one embodiment, the cement additive composition having silicone antifoam composition comprising a silicone polymer, a filler, a surfactant, and water.

The dispersions of the invention may contain silicon dioxide (silicic acids), titanium dioxide or aluminum oxide, preferably having a BET surface area of, from 20 to 1000 m²/g, preferably a particle size of less than 10 μm and a preferably an agglomerate size of less than 100 pm as fillers. The optional fillers are most preferably silicic acids, in particular those having a BET surface area of from 50 to 800 m²/g. These silicic acids may be pyrogenic or precipitated silicic acids. In particular, pretreated silicic acids, such as, for example, commercially available completely or partly hydrophobed silicic acids, can be used as fillers.

In one embodiment, the cement additive composition having the organic additive comprising a diamine or an alkanolamine or hyperbranched polycarboxylate polymer or its mixture thereof.

In one embodiment, the compressive strength improving, water uptake reducing cement additive composition comprising:
a) a self-dispersible mixture additive composition comprising:
an alkylalkoxysilane of formula (I) or its hydrolysate or mixture thereof

(RO)₄₋ₙSiR′ₙ (I)
where, n is any number from 1 to 3,
R is same or different and is a C₁-C₂₀ group,
R′ is same or different and is a C₁-C₂₀ group; and

The hydrolysate of the alkylalkoxysilane of formula (I) is an oligomeric and its mixtures thereof;
b) an additive selected from (a) an amino silane, (b) an amino siloxane or (c) an organic additive comprising selected from a hyperbranched polycarboxylate polymer or molecules having groups NR″₂—, or R″₂N—R′″—NR″— or R″N=NR″, where, R″, R′″ is an optionally substituted aromatic or aliphatic hydrocarbon radical having C1-C20 group, or its mixtures thereof,
c) a silicone antifoam composition, wherein, ratio of self-dispersible mixture to organic additive to silicone antifoam composition is (100 to 20):(80 to 0):(20 to 0).

In one embodiment, the cement additive composition having the self-dispersible mixture additive composition is further added with a protic solvent to form an emulsion. US2018282234 describes a composition comprising a self-dispersible mixture additive composition comprising an alkylalkoxysilane of formula (RO)₄₋ₙSiR′ₙ, or its hydrolysate or mixture thereof, where R is same or different C1-C20, R′ is same or different C1-C20; and which is hereby incorporated by reference.

In one embodiment, the cement composition comprising preferably 0.01% to 2% by weight of a cement additive composition.

In one embodiment, the cement composition having the organic additive comprising a diamine or an alkanolamine or a hyperbranched polycarboxylate polymer or mixture thereof

According to another aspect of the invention, the alkylalkoxysilane of formula (I) is an alkylalkoxy silane selected from trialkylmonoalkoxysilane, dialkyldialkoxysilane, alkyltrialkoxysilane, tetraalkoxysilane. In another embodiment, the alkylsilane of formula (I) is an alkyltrialkoxysilane.

According to another aspect of the invention, the amino siloxane (or silicone) is of formula

XR₂Si(OSiAR)ₙ(OSiR₂)mOSiR₂X (I)
where, A is an amino radical of the formula —R¹—[NR²—R³-]_{X}NR²², or the protonated amino forms of the amino radical A, X is R or A or a hydroxyl or an alkoxy group, R is a monovalent hydrocarbon radical having from 1 to 18 carbon atoms, R¹ is a C1-C6-alkylene radical, preferably a radical of the formula —CH₂CH₂CH₂— or —CH₂CH(CH₃)CH₂—, R² is a hydrogen atom or a C1-C4-alkyl radical, preferably a hydrogen atom, R³ is a C1-C6-alkylene radical, preferably a radical of the formula —CH₂CH₂—, where m+n is a number from 50 to about 500, preferably in the range of about 50 to 300, x is 0 or 1. The mole percent of amine functionality is in the range of from about 0.3 to about 8%. Examples of amino silicones useful in the silicone component of the composition of the invention include trialkylsilyl endblocked amino silicone or amodimethicone, amodimethiconol. In another embodiment, the trialkylsilyl end blocked amino silicone may have some parts by weight of hydroxypolysiloxane or hydroxypolysiloxane. Most preferable amino silicone is a reactive amino fluid having a viscosity of 700-1300 mPa·s at 25° C. (using spindle no 2, rpm 6, Brookfield LVT) and amine value of 15-20 mg of KOH/g.

In one of the embodiments, the amine value is determined by acid-base titration using a potentiometer [Make: Veego; Model: VPT-MG]. 0.6 g of sample is taken in a 500 ml beaker and toluene-butanol 1:1 mixture is added and stirred to mix the sample thoroughly and the sample solution is titrated with a 0.1(N) HCl solution. The amine value is calculated according to the formula (56.11×V×N)/W mg KOH/g of sample, where V=Volume of HCl required in ml, N=Normality of HCl, i.e. 0.1 N, W=Weight of the sample taken in gram.

The viscosity of the fluids, its mixture and the emulsion prepared by the fluid may also be measured at 25° C. by Anton Paar Rheometer; model MCR101, geometry single gap cylinder: CC27 spindle and shear rate 1 s⁻¹, CP25-6 spindle and shear rate 1 s⁻¹.

According to another aspect of the invention, there is provided a process of preparing a mixture additive composition, comprising:
mixing an emulsion comprising:
(A) an alkyl silane or its hydrolysate or mixture thereof comprising a silicon resin comprising units of the formula (Ia)

(R¹O)ₐR²_{b}R³_{c}SiO_{(4-a-b-c)}/2 (Ia),
where,
R¹ is same or different and is hydrogen atom, a monovalent alkyl group with 1-4 carbon atoms,
R² is same or different and is a monovalent alkyl group with 1-3 carbon atoms,
R³ is same or different and is a monovalent alkyl with 4-20 carbon atoms,
a is 0, greater than 0 and less than or equal to 3,
b is 0, greater than 0 and less than or equal to 3,
c is 0, greater than 0 and less than or equal to 3,
with the provisos that a+b+c≤3,
in more than 50 percent of all units of SiO_{3/2} of formula (Ia), b is less than c, where, a, b, c is same or different and are integers or a fraction either each unit or in an average unit.
   and
   optionally mixing one or more non-ionic emulsifier of HLB value between 8 and 20 and its mixtures thereof and then mixing a group of organic compounds from diamine and alkanolamine. (B) optionally, an additive selected from (a) an amino silane, (b) an amino siloxane or (c) an organic additive comprising selected from a hyperbranched polycarboxylate polymer or molecules having groups NR″₂—, or R″₂N—R′″—NR″— or R″N=NR″, where, R″, R′″ is an optionally substituted aromatic or aliphatic hydrocarbon radical having C1-C20 group, or its mixtures thereof.

Then optionally, adding a silicone antifoam composition, wherein, ratio of self-dispersible mixture to organic additive to silicone antifoam composition is from to obtain the compressive strength improving, water uptake reducing cement composition.

In one of the embodiments, the silicone antifoam (or defoamer) composition, comprising:
(A) at least one organosilicon compound comprising units of the formula

R⁷ₐ(R⁸O)_{b}R⁹_{c}SiO_{(4-a-b-c)}/2 (III)
in which,
R⁷ represents a methyl radical, R⁸ each is identical or different and denotes a hydrogen atom or a monovalent, optionally substituted hydrocarbon radical, R⁹ represents a phenyl radical or a monovalent, optionally substituted hydrocarbon radical which is attached to the silicon atom via a carbon ring atom, a is 0, 1, 2 or 3, b is 0, 1, 2 or 3 and c is 0, 1, 2 or 3. The antifoam composition may further comprise silica, surfactant and water.

In one specific embodiment, structure of silicone polymer in the antifoam is as below, R₇(SiOR₈R₉) R₁₀ where R₇ and R₁₀ are same groups or mixture. R₇ and R₁₀ are H, OH or alkyl groups and alkyl chain can be 1 to 12. R₈ and R₉ are same groups or mixture. R₇ and R₁₀ are alkyl groups or aryl groups or mixture thereof. Alkyl chain can be 1 to 12 and aryl groups having carbon number 6 to 20. Silica can be precipitated type or fume or mixture thereof and surface area less than 400 m²/gm. The antifoams are available from Wacker with the brand names Wacker Silfoam, Wacker NE, Wacker Finish, Wacker Powersoft, Wacker SE etc.

In another embodiment, the non-silicone antifoam is selected from a mineral oil, vegetable oil based antifoams, silica etc.

According to another aspect of invention there is provided an emulsion comprising the self-dispersible mixture additive composition and a protic solvent.

In another embodiment, the additive is added to any porous product preferably dry cement to render uniform and long-lasting especially but not limited to bulk hydrophobic property to the final product and at the same time retain the compressive strength made of the porous product.

Solvent contains protic and specifically polar protic solvents. Suitable examples of polar protic solvents include water, propanol, ethanol, and forming acid.

In one of the embodiments the self-dispersible mixture additive composition is preferably without water.

In one of the embodiments, the alkyl silane is an alkylalkoxysilane and preferably a same or different alkyltrialkoxysilane or its hydrolysate or mixture thereof is from 1 to 99 weight percent of the composition, and preferably from 50 to 90 weight percent of the composition. The alkyl alkoxysilane may be prepared by reacting silicon metal with alcohol to form alkoxysilane or by reacting chlorosilane and directly hydrolyzing to obtain the desired silane or its hydrolysate comprising the silicone resin.

The alkyl silane is selected from propyltrimethoxysilane, propyl triethoxy silane, octyltrimethoxysilane, octyltriethoxysilane, isooctyltrimethoxysilane, isooctyltriethoxy silane or its mixtures thereof.

Examples of hydrocarbons R, R′, R¹ are alkyl radicals, such as the methyl, ethyl, n-propyl, isopropyl, 1-n-butyl, 2-n-butyl, isobutyl, tert-butyl, n-pentyl, isopentyl, neopentyl and tert-pentyl radical, hexyl radicals, such as the n-hexyl radical, heptyl radicals, such as the n-heptyl radical, octyl radicals, such as the n-octyl radical and isooctyl radicals, such as the 2,2,4-trimethylpentyl radical, nonyl radicals; such as the n-nonyl radicals, decyl radicals, such as the n-decyl radical, dodecyl radicals, such as the n-dodecyl radical, and octadecyl radicals, such as the n-octadecyl radical; alkenyl radicals such as the vinyl and ally radical; cycloalkyl radicals, such as the cyclopentyl, cyclohexyl, cycloheptyl and methylcyclohexyl radicals; aryl radicals, such as the phenyl, naphthyl, anthryl and phenanthryl radical; alkaryl radicals, such as the o-, m- and p-tolyl radicals, xylyl radicals and ethylphenyl radicals; and aralkyl radicals such as the benzyl radical and the phenylethyl radical or caprylyl radical. R² are alkyl radicals, such as the methyl, ethyl, n-propyl, isopropyl. R³ are alkyl radicals, such as the 1-n-butyl, 2-n-butyl, isobutyl, tert-butyl, n-pentyl, isopentyl, neopentyl and tert-pentyl radical, hexyl radicals, such as the n-hexyl radical, heptyl radicals, such as the n-heptyl radical, octyl radicals, such as the n-octyl radical and isooctyl radicals, such as the 2,2,4-trimethylpentyl radical, nonyl radicals; such as the n-nonyl radicals, decyl radicals, such as the n-decyl radical, dodecyl radicals, such as the n-dodecyl radical, and octadecyl radicals, such as the n-octadecyl radical; alkenyl radicals such as the vinyl and ally radical; cycloalkyl radicals, such as the cyclopentyl, cyclohexyl, cycloheptyl and methylcyclohexyl radicals; aryl radicals, such as the phenyl, naphthyl, anthryl and phenanthryl radical; alkaryl radicals, such as the o-, m- and p-tolyl radicals, xylyl radicals and ethylphenyl radicals; and aralkyl radicals such as the benzyl radical and the phenylethyl radical or caprylyl radical. Most preferred R, R¹, R² is the methyl radical and R′, R³ is preferably from C—C and is preferably but not restricted to, n-propyl, n-octyl, iso-octyl radical.

In one of the embodiments, the non-ionic emulsifier or its mixture is from 99 to 1 weight percent of the composition, preferably from 50 to 10 weight percent of the composition.

In another embodiment of the invention the non-ionic emulsifier is selected from polyoxyalkylene alkyl ether, polyoxyalkylene alkylphenyl ethers and polyoxyalkylene sorbitan esters. Some useful emulsifiers having HLB value in between 8 and 20 are polyethylene glycol octyl ether; polyethylene glycol lauryl ether; polyethylene glycol tridecyl ether; polyethylene glycol cetyl ether; polyethylene glycol mixed alkyl ether; polyethylene glycol cetyl oleyl ether, polyethylene glycol stearyl ether; polyethylene glycol nonylphenyl ether; polyethylene glycol dodecylphenyl ether; polyethylene glycol cetylphenyl ether; polyethylene glycol stearylphenyl ether; polyethylene glycol sorbitan mono stearate and poly ethylene glycol sorbitan mono oleate.

The self-dispersible mixture additive composition is dispersed in aprotic solvent preferably an aqueous solvent. The aqueous solvent is preferably water.

The composition according to the invention is an oil-in-water emulsion. In an emulsion, one liquid (the dispersed phase) is dispersed in the other (the continuous phase). According to the inventive oil-in-water emulsion the self-dispersible mixture additive composition (the dispersed phase) is dispersed in the continuous water phase. The emulsion may be a micro emulsion or a macro emulsion. In one of the specific embodiments the active content of the emulsion is between 10 to 90 percent and preferably between 30 to 80 percent.

HLB values are typically referred to the values at room temperature (25° C.). As temperature varies, the HLB value of a surfactant/emulsifier may also vary. Calculation of HLB value of non-ionic surfactants/emulsifiers is calculated according to the equations: HLB=(E+P)/5; E=weight percentage of oxyethylene content; P=weight percentage of polyhydric alcohol content (glycerol, sorbitol, etc.) provided according to the terms of the HLB system of emulsifier classification introduced by Griffin, W. C., “Calculation of HLB Values of non-ionic Surfactants”, Journal of COSMETIC SCIENCE, Vol. 5, No. 4, January 1954, 249-256 (1954).

For ionic surfactants/emulsifiers, the HLB value of individual surfactant/emulsifier molecules can be calculated applying the Davies formula as described in Davies JT (1957), “A quantitative kinetic theory of emulsion type, I. Physical chemistry of the emulsifying agent”, Gas/Liquid and Liquid/Liquid Interface (Proceedings of the International Congress of Surface Activity): 426-38.

Emulsifier's mixture having HLB value in between 10-16 are suitable to make the emulsion process simpler. When two emulsifiers A and B of known HLB are thus blended for use the HLB_{Mix} is said to be the required HLB for the mixture. This is expressed by the equation (W_{A}HLB_{A}+W_{B}HLB_{B})/(W_{A}+W_{B})=HLB_{Mix}, where W_{A}=the amount (weight) of the first emulsifier (A) used, and W_{B}=the amount (weight) of the second emulsifier (B); HLB_{A}, HLB_{B}=the assigned HLB values for emulsifiers A and B; HLB_{Mix}=the HLB of the mixture.

Non-ionic emulsifiers having HLB value between 8 to 20 and preferably, in one embodiment at least one emulsifier or a mixture of emulsifier having an HLB value from 10-16 has a great importance in the present invention to make process simpler. In another embodiment the emulsifier is most preferably a mixture of nonionic emulsifiers. In another embodiment a cationic or anionic emulsifier may be selected as an emulsifier.

In another embodiment of the invention, the organic additive having the generic structure NR″₃, R″₂N—R′″—NR″₂, R″N=NR″, wherein R″ is a monovalent, optionally substituted hydrocarbon radical having C₁-C₂₀ group, R′″ is a optionally substituted aromatic or aliphatic group having C1-C20 group. The organic additive is chosen from but not limited to ethylene diamine with general formula R1R2N(CH2)2NR3R4 or diamine derivative with general formula R1N=NR2 and

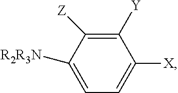

### Where R1, R2, R3 and R4=—H, —CH3, —C2H5, —C3H7, —C4H9, —C2H4OH, —CH(CH2OH)C2H5, Phenyl and X, Y and Z is —H, —NR1R2, and

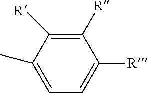

where R′, R″ and R′″ is —H, -Me, -Et or —Pr, —NR1R2 or alkanolamine with general formula NHmR5OH (3-m) Where R5 is alkylene gr with carbon chain from 1 to 6 and m=0 to 2 or mixture thereof.

In another embodiment of the invention, the organic additive is selected from but not limited to a ethylene diamine or derivative such as tetrahydroxylethylethylene diamine (THEED), diethylene glycol (DIEG), 1,1-dimethylethylenediamine, 1,2-dimethylethylenediamine, ethambutol, tetrakis(dimethylamino)ethylene (TMEDA), dimethyl-4-phenylenediamine, N,N′-di-2-butyl-1,4-phenylenediamine, 4,4′-diaminobiphenyl, 1,8-diaminonaphthalene, o-phenylenediamine (OPD), m-phenylenediamine (MPD) p-phenylenediamine (PPD) 2,5-diaminotoluene, o-xylylenediamine (OXD), m-xylylenediamine (MXD), p-xylylenediamine (PXD), 1,2-diaminopropane, diphenylethylenediamine, 1,2-diaminocyclohexane, 1,3-diaminopropane, putrescine, cadaverine and an alkanolamine such as triethanolamine (TEA, diisopropanolamine (DIPA), Diethanol Isopropanolamine (DEIPA), triisopropanolamine (TIPA), triethanolamine acetate (TEAA), N, N-bis(2-hydroxyethyl)-2-propanolamine.

In one of the other embodiments, the amine organic additive is a mixture of diamine and alkanolamine. In one of the preferred compositions, the ratio of diamine:alkanolamine is from 99.5:0.5 to 0.5 to 99.5, and more preferably from 95:5 to 5:95. The dosage by weight on cement can range from 0.001% S/s to 0.5% S/s, with the preferred range being 0.01% to 0.1% S/s.

In another embodiment of the present invention, organic additive is selected from but not limited to hyperbrached polycarboxylated having anionic backbone and several nonionic pendent chains which typically are comprised of poly alkylene glycols or a hyperbranched carboxylates build up from linear polyalkylene amine and a hyperbranched polyglycerol scaffold which is carboxymethylated in the periphery. Average molecular weight is always more than 2000 gm/mole.

Formulation with an alkylalkoxysilane of formula (I) or its hydrolysate or their mixture and an aminopolysiloxane. Alkylalkoxysilane of formula (I) or its hydrolysate or their mixture and an aminopolysiloxane with a ratio 99:1 to 1:99, Preferable 80:20 to 20:80, Most preferably 60:40 to 40:60. Aminopolysiloxane can be derived with Dimethylcyclosiloxane, Polydimethylsiloxane or fluid through cracking (Polymer LGS). Modified with diethylene triamine, 2-Aminoethyl)-3-aminopropyl, 2-Aminoethyl-3-aminopropylmethyl, 3-aminopropyl etc.

Dosing of test composition: PORTLAND cement (Portland cement, Class C) is used as base cement. It is treated with the inventive and non-inventive composition by mixing in three different scenarios to test the hydrophobicity, strength of the final composite:
(a) before grinding to measure the energy requirement and the distribution of the additives.
(b) after the grinding process is done and mixing grinding aid composition for comparative test the final hydrophobicity and strength.
(c) after slag is mixed with the grinded cement then mixing grinding aid composition for comparative test the final hydrophobicity and strength.

Grinding trial may be done in a ball mill, and energy required is measured by an external energy measuring device. The energy consumption can be determined by the power consumption and a fixed operating time of the mill. The power used by the ball mill is calculated by multiplying the electric current and voltage are measured by ammeter and voltmeter which are connected to the electrical cabinet of the ball mill. The properties of the final grinded cement may be measured by the determination of fineness after grinding (DIN EN 196-6) and the surface area of the solid (DIN ISO 9277) tests.

The following examples serve for the detailed illustration of the invention and should in no way be understood as being limiting.

### Examples

### Preparations:

(a) Hydrolysed n-Octyltriethoxysilane Preparation:
n-Octyltriethoxysilane: 3300 g
Conc H₂SO₄: 7.2 g
Water 108 g
is taken in a reactor and temperature at 85° C. reflux and finally distilled out all volatiles (Yield: 92%) and then neutralize by Triethanolamine to get the hydrolyzed n-Octyltriethoxysilane (also called oligomeric silane). The hydrolyzed n-Octyltriethoxysilane is having greater than one unit.

### (b) Silicon Resin Composition Preparation (Inventive Composition):

70% n-Octyltriethoxysilane (and 30% of n-methyltriethoxysilane): 3300 g
Conc H2SO4: 7.2 g
Water 108 g

### (c) Silicon Resin Composition Preparation (Non-Inventive Composition):

30% n-Octyltriethoxysilane (and 70% of n-methyltriethoxysilane): 3300 g
Conc H2SO4: 7.2 g
Water 108 g

Composition above (a), (b) and (c) are taken in a reactor and temperature at 85° C. reflux and finally distilled out all volatiles (Yield: 92%) and then neutralize by Triethanolamine to get the silicon resin (or hydrolyzed alkoxysilane). The silicon resin is having greater than one siloxy unit having a viscosity of ˜12-17 mPas at 25° C. The silicon resin may be defined as a methyl-octyl-methoxy resin where every Si-atom is bonded to exactly one octyl or methyl group with the above-mentioned methyl-octyl ratio, and every Si-atom is bonded to 0-3 methoxy groups. A continuous method of synthesis is described in the Wacker Chemie patent U.S. Pat. No. 7,339,069 titled continuous process for preparing SiOC-containing compound and is further incorporated as reference. Some applications are also further described in the Wacker published application US20210130550 of the use of alkyl silicone resin as additive for hydrophilizing fiber which is further incorporated as reference.
d) Mixture composition of the silicon resin (both inventive and non-inventive) is mixed with the silane composition to form a mixture composition for the experiments.
e) The inventive (and also comparative) oil-in-water emulsion is formed by adding the silicon resin composition (the dispersed phase) is dispersed in the continuous water phase. In one of the other embodiments, a catalyst may be incorporated in the emulsion for the resin to react, though such composition has to be used readily since the composition will react and crosslink to become hardened and having no further reactivity.

### A) Performance Test

The comparative performance test is performed for the Mortar prepared by inventive compressive strength improving, water uptake reducing cement additive composition which also acts as a grinding aid composition, the blank Portland cement, reference sample (without any additive).

### Mortar Testing:

Composition: Sand—1200 g; Cement—400 g; Water—240 g Preparation of test specimens Materials for the control mix and test mix, and molds for the test specimens, shall be conditioned for at least 24 h before use. Conditioning shall be by placing in an enclosure maintained at (20±2) ° C. and (65±5) % relative humidity.

Mixing of the mortar shall be as described in EN 480-1. Mortar specimens (40×40×160) mm shall be prepared as described in EN 196-1, except that the molds shall not be oiled.

When testing at equal w/c ratio, the water content of the admixture shall be taken into account when calculating the required water content of the mortar.

In case the test mix shall have the same consistence as the control or reference mix this shall be measured by using the workability meter in accordance with EN 413-2. The following equipment is considered for performing the test Tonimix mixture, Germany (Zwick Rolle).

### Test for Hydrophobicity:

Hydrophobicity for Cement composition: Preparation is done for comparative data having the similar % dosing of silicon composition in the final cement mixture. The dry cement block is prepared, the cement there by produced is compacted in a petri-dish (90×15 mm) and level on the top using a smooth glass rod. Then placed 5 water droplet using disposable dropper (Tarson 940050 LDPE Pasteur Pipette) over the cement surface and start stopwatch. The time to disappear the water drop is noted, which is an indicator of water repellency or hydrophobicity, and beading time test is done to record the time to disappear of water droplet in Table 1.

Measurement of Rate of Absorption of Water for Mortar Composition: mortar shall be as described in EN 480-1. Mortar specimens (40×40×160) mm shall be prepared as described in EN 196-1. To test the hydrophobicity, evaluation for water absorption as specified in ASTM C1585 in 24 hours or 96 hours.

Test for Compressive strength (CS): CS is measured according to the standard DIN EN 12390-3 (for concrete) or DIN EN 196-1 (for mortar) and noted in Table 2 in MPa after 1 day, 14 days and 28 days respectively as needed to compare with the prior art references on the prepared mortar specimen as described in EN 196-1. Though the test is performed on mortar composition, but it may not be restricted to mortar and is also applicable for concrete or plaster and its final composition.

TABLE 1
Comparative study of the compressive strength of the mortar composition and hydrophobicity of the cement composition
having the inventive additive composition with respect to the reference and prior art compositions

| | | | | | | | Hydrophobicity/ | |
|---|---|---|---|---|---|---|---|---|
| | | | | | | | water uptake | |
| | | | Dosage | | | | reducing for | |
| | | | (ppm) | 1-day | 14 days | 28 days | cement | |
| | | | silane/ | Compressive | Compressive | Compressive | composition | |
| Exp. | | Description of | silane | Strength | Strength | Strength | (Beading Time | |
| No. | | composition | oligomer | (MPa) | (MPa) | (MPa) | in minutes) | |
| 1 | Non- | Reference (without | | | 38.14 | 45.22 | 0 | min |
| | inventive | any additive) | | | | | | |
| 2 | Non- | Octyltrialkoxysilane | 400 | | 28.6 | 36.8 | >120 | min |
| | inventive | (alkylalkoxysilane) | | | | | | |
| | (reference | | | | | | | |
| | regular | | | | | | | |
| | hydrophobic | | | | | | | |
| | cement) | | | | | | | |
| 3 | Non- | Oligomeric silane | 400 | | 32.1 | 37.1 | >120 | min |
| | inventive | (hydrolysate of | | | | | | |
| | (hydrolysate | alkylalkoxysilane) | | | | | | |
| | treated | | | | | | | |
| | hydrophobic | | | | | | | |
| | cement) | | | | | | | |
| 4 | Non- | Oligomeric silane | 400 | | 32.55 | 38.15 | | |
| | Inventive | 400 ppm + | | | | | | |
| | | Additive* 210 ppm | | | | | | |
| | | added separately | | | | | | |
| 5 | Non- | Mixed Octylsilane | 400 | | 37.2 | 39.5 | >120 | min |
| | Inventive | 400 ppm + | | | | | | |
| | | Additives* (in | | | | | | |
| | | solvent) 210 ppm | | | | | | |
| 6 | Non- | Mixed Octylsilane | 400 | | 29.5 | 37.4 | >120 | min |
| | Inventive | 400 ppm + | | | | | | |
| | | Additives* 210 ppm | | | | | | |
| | | emulsion | | | | | | |
| 7 | Non- | Mixed Oligomeric | 400 | | 34.04 | 36.51 | >120 | min |
| | Inventive | silane 400 ppm + | | | | | | |
| | | Additives* 210 ppm | | | | | | |
| | | emulsion | | | | | | |
| 8 | Inventive | Mixed Octylsilane | 400 | | 38.1 | 41.5 | >120 | min |
| | | 400 ppm + | | | | | | |
| | | Additives 210 | | | | | | |
| | | ppm + Antifoam** | | | | | | |
| | | emulsion 42 ppm | | | | | | |
| 9 | Inventive | Mixed Oligomeric | 400 | | 35.81 | 42.06 | >120 | min |
| | | silane 400 ppm + | | | | | | |
| | | Additives* 210 | | | | | | |
| | | ppm + Antifoam ** | | | | | | |
| | | emulsion 42 ppm | | | | | | |
| 10 | Non- | Reference + Added | | | 37.85 | 44.45 | 0 | min |
| | inventive | Antifoam** | | | | | | |
| | | emulsion 42 ppm | | | | | | |
| 11 | Non- | Mixed Octylsilane | 400 | | 29.2 | 37.1 | >120 | min |
| | inventive | 400 ppm + | | | | | | |
| | | Antifoam** | | | | | | |
| | | emulsion 42 ppm | | | | | | |
| 12 (a) | Inventive | Mixed Oligomeric | 400 | | 34 | 35.8 | >120 | min |
| | | silane 400 ppm + | | | | | | |
| | | Antifoam** | | | | | | |
| | | emulsion 42 ppm | | | | | | |
| 12 (b) | Inventive | Mixed Oligomeric | 400 | | 35 | 36 | >120 | min |
| | | silane 400 ppm + | | | | | | |
| | | Antifoam** 42 ppm | | | | | | |
| | | self dispersible | | | | | | |
| 13 | Inventive | Mixed Oligomeric | 400 | | 33.05 | 40.12 | >120 | min |
| | | silane 400 ppm + | | | | | | |
| | | Additives* 210 | | | | | | |
| | | ppm + Antifoam** | | | | | | |
| | | in solvent 42 ppm | | | | | | |
| 14 | Non- | Mixed Oligomeric | 400 | | 32.2 | 37.3 | >120 | min |
| | Inventive | silane part I + | | | | | | |
| | | Additives + | | | | | | |
| | | Antifoam Part II(out | | | | | | |
| | | of range) (Part | | | | | | |
| | | I:Part II = 92:8) | | | | | | |
| 15 | Non- | Mixed Oligomeric | 400 | | 29.65 | 36.14 | ~1 | min |
| | inventive | silane + | | | | | | |
| | | Additives* + | | | | | | |
| | | Antifoam (out of | | | | | | |
| | | range) (Part I:Part | | | | | | |
| | | II = 8:92) | | | | | | |
| 16 | Non- | 25 ppm THEED | 25 | 11.8 (in | 35.898 | 42.89 | 0 | min |
| | inventive | (Comparative | | 1 day) | | | | |
| | | Examples of 5 in | | | | | | |
| | | patent number | | | | | | |
| | | US7160384B2) | | | | | | |
| 17 | Non- | 25 ppm DEIPA | 25 | 11.6 (in | 38.84 | 46.12 | 0 | min |
| | inventive | (Comparative | | 1 day) | | | | |
| | | Examples of 5 in | | | | | | |
| | | patent number | | | | | | |
| | | US7160384B2) | | | | | | |
| 18 | Non- | 25 ppm THEED and | 25 | 13.2 (in | 40.15 | 46.23 | 0 | min |
| | inventive | 25 ppm DEIPA | | 1 day) | | | | |
| | | mixture | | | | | | |
| | | (Comparative | | | | | | |
| | | Examples of 5 in | | | | | | |
| | | patent number | | | | | | |
| | | US7160384B2) | | | | | | |
| 19 | Inventive | Mixed*Silane | 25 | 12.6 (in | 36.52 | 48.15 | >45 | min |
| | | oligomer 25 ppm + | | 1 day) | | | | |
| | | additive* 13.1 | | | | | | |
| | | ppm + antifoam** | | | | | | |
| | | 2.6 ppm in solvent | | | | | | |
| 20 | Inventive | Mixed Silane | 25 | 12.9 (in | 37.02 | 48.66 | >45 | min |
| | | oligomer 25 ppm + | | 1 day) | | | | |
| | | additive* 13.1 ppm + | | | | | | |
| | | antifoam in | | | | | | |
| | | emulsion 2.6 ppm | | | | | | |
| 21 | Non- | 3- | 400 | | | 44.32 | ~50 | min |
| | inventive | aminopropyltriethoxy | | | | | | |
| | | silane and | | | | | | |
| | | isobutyltrimethoxysilane | | | | | | |
| | | condensate as | | | | | | |
| | | per Patent | | | | | | |
| | | US2013092052 | | | | | | |
| | | (400 ppm) | | | | | | |
| 22 | Non- | Transesterified | 400 | 39.3 (in | | 44.8 | ~1 | min |
| | Inventive | product from | | 28 days) | | | | |
| | | Methyltrimethoxysilane | | | | | | |
| | | (MTMS) and | | | | | | |
| | | ethanolamine (1:1) | | | | | | |
| | | as per Patent | | | | | | |
| | | WO11128127 | | | | | | |
| 23 | Non- | DPR GEL is | | | | 35.3 | 0 | min |
| | Inventive | prepared as | | | | | | |
| | | described in patent | | | | | | |
| | | US6635109B1 | | | | | | |
| 24 | Non- | DCC 8 is PDMS | 400 | 9.72 | | 19.28 | ~43 | min |
| | inventive | and received from | | | | | | |
| | | Wacker having a | | | | | | |
| | | viscosity of 78 | | | | | | |
| | | mPa · s and having a | | | | | | |
| | | hydroxyl content of | | | | | | |
| | | 1.22 wt % as per | | | | | | |
| | | WO2000039046A1 | | | | | | |
| 25 | Non- | DCC 9 mixture of I | 400 | 9.97 | | 19.84 | ~37 | min |
| | inventive | and II, Part I is | | | | | | |
| | | prepared by mixing | | | | | | |
| | | a mixture D5 (22%), | | | | | | |
| | | D4 (77%) and | | | | | | |
| | | dimethylcyclosiloxanes | | | | | | |
| | | (1%). All of | | | | | | |
| | | them are received | | | | | | |
| | | from Wacker. Part | | | | | | |
| | | II is 32% sodium | | | | | | |
| | | methylsiliconate | | | | | | |
| | | solution in | | | | | | |
| | | water. As per | | | | | | |
| | | WO2000039046A1 | | | | | | |
| 26 | Non- | 5.1% Methyl | 200 | | | 23.38 | ~3 | min |
| | inventive | silicone oil, 4.0% | | | | | | |
| | | triethanolamine, | | | | | | |
| | | 7.5% | | | | | | |
| | | polytetrahydrofuran | | | | | | |
| | | diol, 4.0% sodium | | | | | | |
| | | silicate, 3.8% | | | | | | |
| | | carboxyethyl | | | | | | |
| | | methylcellulose, | | | | | | |
| | | 9.1% molasses, | | | | | | |
| | | 4.8% fumed silica | | | | | | |
| | | (100 nm), 2.4% | | | | | | |
| | | calcium | | | | | | |
| | | lignosulfonate and | | | | | | |
| | | 59.1% water | | | | | | |
| | | prepared in lab. as | | | | | | |
| | | per example 1 of | | | | | | |
| | | CN107601959A | | | | | | |
| 27 | Non- | Dimethy silicone | 400 | | | 36.2 | ~20 | min |
| | inventive | fluid, Wacker AK10 | | | | | | |
| 28 | Non- | Hydrogen silicone | 400 | | | 35.4 | ~26 | min |
| | inventive | fluid, Crosslinker | | | | | | |
| | | V90 | | | | | | |
| 29 | Non- | Used Additive | | | 42.5 | 48.8 | 0 | min |
| | inventive | II*** 840 ppm | | | | | | |
| 30 | inventive | Mixed Octylsilane | 400 | | 36.95 | 42.62 | >120 | min |
| | | 400 ppm + Additive | | | | | | |
| | | II*** emulsion 840 | | | | | | |
| | | ppm | | | | | | |
| 31 | - inventive | Mixed Oligomeric | 400 | | 37.53 | 43.95 | >120 | min |
| | | silane 400 ppm + | | | | | | |
| | | Additive II*** | | | | | | |
| | | emulsion 840 ppm | | | | | | |
| 32 | Inventive | Mixed Octylsilane | 400 | | 41.25 | 47.42 | >120 | min |
| | | 400 ppm + Additive | | | | | | |
| | | II 840 ppm + | | | | | | |
| | | Antifoam** | | | | | | |
| | | emulsion 42 ppm | | | | | | |
| 33 | Inventive | Mixed Oligomeric | 400 | | 42.37 | 48.95 | >120 | min |
| | | silane 400 ppm + | | | | | | |
| | | Additive II 840 | | | | | | |
| | | ppm + Antifoam** | | | | | | |
| | | emulsion 42 ppm | | | | | | |
| 34 | Non- | Oligomeric silane | 400 | | 32.0 | 37.5 | >120 | min |
| | inventive | emulsion | | | | | | |
| 35 | Inventive | Silane oligomer + | 400 | | 36.89 | | >120 | min |
| | | aminosiloxane of | | | | | | |
| | | viscosity 700- | | | | | | |
| | | 1300 mPa · s at | | | | | | |
| | | 25° C. and amine | | | | | | |
| | | value 15-20 | | | | | | |

*Additives: Ethoxylated Alcohol 9.3%, THEED 6.7%, Alkanolamine 13.3%
**Antifoam: Wacker silicone-based antifoam
***Additive II: Hyperbranched carboxylate polymer

TABLE 2
Comparative study of hydrophobicity of the mortar composition having the inventive
additive composition relative to the reference and prior art compositions

| | | Description of | Hydrophobicity for |
|---|---|---|---|
| Exp. | | composition and | mortar composition |
| No. | | Dosage | (water absorption, in g) |
| 36 | Non- | 1% Na Oleate as in as | Evaluated for water absorption as specified |
| | inventive | described in | in ASTM C1585 In 96 hours = 17 grams |
| | | WO2019101811A1 | |
| 37 | Non- | 1% Ca Stearate | Evaluated for water absorption as specified |
| | inventive | | in ASTM C1585 In 96 hours = 11 grams |
| 38 | Non- | 0.25% RainBloc ®80 | Evaluated for water absorption as specified |
| | inventive | | in ASTM C1585 In 96 hours = 29 grams |
| 39 | Non- | Control (without | Evaluated for water absorption as specified |
| | inventive | any additive) | in ASTM C1585 In 96 hours = 106 grams |
| 40 | Inventive | 0.25% Silane oligomer | Evaluated for water absorption as specified |
| | | with additive and | in ASTM C1585 In 96 hours = 9 grams |
| | | antifoam emulsion* | |
| 41 | Inventive | 0.25% Silane oligomer | Evaluated for water absorption as specified |
| | | with additive and | in ASTM C1585 In 96 hours = 9 grams |
| | | antifoam emulsion*** | |
| 42 | Inventive | 0.25% Silane oligomer | Evaluated for water absorption as specified |
| | | and antifoam self- | in ASTM C1585 In 96 hours = 9 grams |
| | | dispersible | |
| 43 | Inventive | 0.25% Silane oligomer | Evaluated for water absorption as specified |
| | | and aminosiloxane of | in ASTM C1585 In 96 hours = 9 grams |
| | | viscosity 700-1300 | |
| | | mPa · s at 25° C. and | |
| | | amine value 15-20 | |

*Additives: Ethoxylated Alcohol 9.3%, THEED 6.7%, Alkanolamine 13.3%
**Antifoam: Wacker silicone-based antifoam
***Additive: Hyperbranched carboxylate polymer

### OBSERVATION FROM THE EXPERIMENT

It is observed that inventive Experiment in Table 1 where the Experiment no. 8, 9 indicate that by loading or mixing the inventive compressive strength improving, water uptake reducing cement additive composition to the PPC cement, the compressive strength increases up to 14% for Exp. 9, [(42.06-36.8)/36.8=14%] with respect to the non-inventive regular hydrophobic octyl silane cement composition of Exp. no. 2 and both exp 2 and 9 are comparable in hydrophobicity and the hydrophobicity drastically improves with respect to the reference of non-inventive Exp. no. 1 i.e. reference, without any additive.

Further, although non-inventive Ex 10 including reference+Antifoam** emulsion has CS values are 37.85 and 44.45 respectively, the hydrophobicity value is 0 min which is almost similar to Ex-1 (reference cement) thereby indicating antifoam has not effect in hydrophobicity as well in strength improvement.

Even in Exp 5, 6, 7, 11, 12, the addition of organic additive with alkyl silane or hydrolyzed alkylsilane and addition of antifoam with alkyl silane or hydrolyzed alkylsilane in solvent or emulsion form do not provide optimum improvement in compressive strength improvement and superior hydrophobicity value.

Surprisingly, synergic improvement was observed in compressive strength and hydrophobicity value when invented composition comprising alkyl silane or hydrolyzed alkylsilane along with organic additive and antifoam are added in the cement as demonstrated in Ex 8, 9, 19, 20, 32, 33, 38 and 39 respectively. Similarly, in exp 4, 29, it is observed that the addition of organic additive do not deliver the optimum improvement in compressive strength and hydrophobicity in mortar but surprisingly synergic improvement observed in exp Ex 8, 9, 19, 20, 32, 33, 35, 40-43 in compressive strength and hydrophobicity when invented composition comprising alkyl silane or alkyl silane hydrolysate and organic additive and silicone antifoam added in cement grinding.

Thus, the current inventive composition acts as a grinding aid before or during grinding and also drastically improves hydrophobicity property in the cement, plaster and the mortar composition thus retaining the compressive strength of the composition.

1. A compressive strength improving, water uptake reducing additive composition comprising:
an alkyl silane or its hydrolysate or mixture thereof comprising a silicon resin comprising units of the formula (Ia)
(R¹O)ₐR²_{b}R³_{c}SiO_{(4-a-b-c)}/2 (Ia),
where,
R¹ is same or different and is hydrogen atom, a monovalent alkyl group with 1-4 carbon atoms,
R² is same or different and is a monovalent alkyl group with 1-3 carbon atoms,
R³ is same or different and is a monovalent alkyl with at least 4 carbon atoms,
a is 0, greater than 0 and less than or equal to 3,
b is 0, greater than 0 and less than or equal to 3,
c is 0, greater than 0 and less than or equal to 3,
with the provisos that a+b+c≤3,
in more than 50 percent of all units of formula (Ia), b is less than c, where, a, b, c is same or different and are integers or a fraction either each unit or in an average unit.

2. The additive composition of claim 1, the alkyl silane of formula (Ib) or its hydrolysate or mixture thereof
(X)₄₋ₙSiR′ₙ (Ib)
where, n is any number from 1 to 3,
X is same or different and is a halide, —OR,
R is same or different and is a C₁-C₂₀ group,
R′ is same or different and is a C₁-C₂₀ group.

3. The additive composition of claim 1, further comprising an antifoam composition selected from a group comprising a silicone antifoam composition and a non-silicone antifoam composition and its mixtures thereof.

4. The additive composition of claim 1, further comprising:
an additive selected from (a) an amino silane, (b) an amino siloxane or (c) an organic additive selected from a hyperbranched polycarboxylate polymer or molecules having groups NR″₂—, or R″₂N—R′″—NR″— or R″N=NR″, where, R″, R′″ is an optionally substituted aromatic or aliphatic hydrocarbon radical having C₁-C₂₀ group, or its mixtures thereof.

5. The additive composition of claim 1, wherein R¹, R² is methyl or ethyl and R³ is octyl or iso-octyl group.

6. The additive composition of claim 1, wherein the alkyl silane of formula (I) or its hydrolysate or mixture composition is emulsified or is in a solvent.

7. The additive composition of claim 3, the silicone antifoam composition comprising a silicone polymer, a silica, a surfactant, and water.

8. The additive composition of claim 4, wherein the organic additive comprising a diamine or an alkanolamine or its mixture thereof.

9. A compressive strength improving, water uptake reducing,
self-dispersible mixture additive composition comprising:
an alkyl silane or its hydrolysate or mixture thereof comprising a silicon resin comprising units of the formula (Ia)
(R¹O)ₐR²_{b}R³_{c}SiO_{(4-a-b-c)}/2 (Ia),
where,
R¹ is same or different and is hydrogen atom, a monovalent alkyl group with 1-4 carbon atoms,
R² is same or different and is a monovalent alkyl group with 1-3 carbon atoms,
R³ is same or different and is a monovalent alkyl with 4-20 carbon atoms,
a is 0, greater than 0 and less than or equal to 3,
b is 0, greater than 0 and less than or equal to 3,
c is 0, greater than 0 and less than or equal to 3,
with the provisos that a+b+c≤3,
in more than 50 percent of all units of formula (Ia), b is less than c, where, a, b, c is same or different and are integers or a fraction either each unit or in an average unit.

10. The compressive strength improving, water uptake reducing self-dispersible mixture additive composition of claim 9, further comprising an antifoam composition selected from a group comprising a silicone antifoam composition and a non-silicone antifoam composition and its mixtures thereof.

11. The compressive strength improving, water uptake reducing self-dispersible mixture additive composition of claim 9, further comprising:
an additive selected from (a) an amino silane, (b) an amino siloxane or (c) an organic additive selected from a hyperbranched polycarboxylate polymer or molecules having groups NR″₂—, or R″₂N—R′″—NR″— or R″N=NR″, where, R″, R′″ is an optionally substituted aromatic or aliphatic hydrocarbon radical having C₁-C₂₀ group, or its mixtures thereof.

12. The compressive strength improving, water uptake reducing self-dispersible mixture additive composition of claim 9, wherein the alkyl silane of formula (Ia) or its hydrolysate or mixture composition is emulsified or is in a solvent.

13. A compressive strength improving, water uptake reducing cement composition comprising:
a) 0.01 to 5% by weight of a compressive strength improving, water uptake reducing additive composition comprising:
an alkyl silane or its hydrolysate or mixture thereof comprising a silicon resin comprising units of the formula (Ia)
(R¹O)ₐR²_{b}R³_{c}SiO_{(4-a-b-c)}/2 (Ia),
where,
R¹ is same or different and is hydrogen atom, a monovalent alkyl group with 1-4 carbon atoms,
R² is same or different and is a monovalent alkyl group with 1-3 carbon atoms,
R³ is same or different and is a monovalent alkyl with 4-20 carbon atoms,
a is 0, greater than 0 and less than or equal to 3,
b is 0, greater than 0 and less than or equal to 3,
c is 0, greater than 0 and less than or equal to 3,
with the provisos that a+b+c≤3,
in more than 50 percent of all units of formula (Ia), b is less than c, where, a, b, c is same or different and are integers or a fraction either each unit or in an average unit;
b) 15% to 35% of a pozzolanic material; and
c) 60% to 80% of a clinker.

14. The cement composition of claim 13, wherein the organic additive comprising a diamine or an alkanolamine or its mixture thereof.

15. A cement mortar or concrete composition comprising:
I) a cement composition comprising:
0.01 to 5% by weight of a cement additive composition comprising:
a) 0.01 to 100% of a compressive strength improving, water uptake reducing additive composition comprising:
an alkyl silane or its hydrolysate or mixture thereof comprising a silicon resin comprising units of the formula (Ia)
(R¹O)ₐR²_{b}R³_{c}SiO_{(4-a-b-c)}/2 (Ia),
where,
R¹ is same or different and is hydrogen atom, a monovalent alkyl group with 1-4 carbon atoms,
R² is same or different and is a monovalent alkyl group with 1-3 carbon atoms,
R³ is same or different and is a monovalent alkyl with 4-20 carbon atoms,
a is 0, greater than 0 and less than or equal to 3,
b is 0, greater than 0 and less than or equal to 3,
c is 0, greater than 0 and less than or equal to 3,
with the provisos that a+b+c≤3,
in more than 50 percent of all units of formula (Ia), b is less than c, where, a, b, c are same or different and are integers or a fraction either each unit or in an average unit.
b) 0 to 69.99% of an additive selected from (a) an amino silane, (b) an amino siloxane or (c) an organic additive selected from a hyperbranched polycarboxylate polymer or molecules having groups NR″₂—, or R″₂N—R′″—NR″— or R″N=NR″, where, R″, R′″ is an optionally substituted aromatic or aliphatic hydrocarbon radical having C₁-C₂₀ group, or its mixtures thereof;
c) 0 to 30% of an antifoam composition selected from a silicone antifoam composition and a non-silicone antifoam composition and its mixtures thereof; and
II) a silica composition,
wherein, the concrete or mortar composition having a compressive strength improvement in the range of 10 to 30% determined according to DIN EN 12390-3 or DIN EN 196-1 respectively and having a reduction of water uptake in the range of 10 to 40% according to ASTM C1585 in the concrete or mortar.

16. (canceled)
